(19) United States
(12) Patent Application Publication
(10) Pub. No.: US 2003/0105667 A1
(43) Pub. Date: Jun. 5, 2003

(54) System for targeting information to consumers at a location

(75) Inventor: Marshall R. Millikan, Suwanee, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/005,249

(22) Filed: Dec. 3, 2001

(51) Int. Cl. G06F 17/60

(52) U.S. Cl. 705/14

(57) ABSTRACT

A consumer messaging system provides targeted messages to particular consumers or particular groups of consumers at a specific location. The targeted messages may be advertisements, promotions, events, or information/data relating to other products and/or services that are tailored to the particular consumer or group of consumers. The specific location may be a store or a place within a store. The consumer messaging system further provides the targeted messages to the consumer or groups of consumers when the consumer or group of consumers is at a point of decision.

### BACKGROUND

1. Field of the Invention

The present invention relates generally to systems for providing information to consumers and, more particularly, to a system for providing targeted information to consumers at a location.

2. Background Information

Advertising is a known method of trying to persuade a consumer to purchase a particular product or service. Such advertising can be packaged in many forms. Some of the forms of advertising are coupons, offers, promotions, audio/video messages, and the like. One drawback to such advertising is that it is generic. In other words, such advertising is provided to a consumer without knowledge of whether the product and/or service being advertised is something that the consumer would want.

Because of the problem of “generic advertising”, retailers are now trying to provide advertisements to specific consumers or attempting to focus their advertising efforts to consumers. To this end, large data warehouses are used in an attempt to feed offers, promotions, and other advertisements to consumers. These efforts, however, fall short since the advertisements are still provided in a non-discriminatory manner to consumers, or by providing the advertisement post-sale. In one instance, such advertisements in the form of offers or coupons are provided to a consumer post-purchase either at the checkout or in the mail thereafter. Regardless of the form, current advertising schemes are either generic or occur after a consumer purchasing decision has already been made.

It would thus be advantageous to provide a message to a consumer that is specifically targeted to the consumer.

It would thus be further advantageous to provide a targeted message to a consumer at a point of purchase decision for the consumer.

It would thus be still further advantageous to provide targeted messages to a group of consumers.

It would thus be even further advantageous to provide targeted messages to a group of consumers at a point of purchase decision for the group of consumers.

What is therefore needed is a system for providing a message to a consumer that is targeted to the consumer.

What is therefore further needed is a system for providing a targeted message to a consumer at a point of decision for the consumer.

What is therefore still further needed is a system for providing targeted messages to a group of consumers during purchase decision periods of the group of consumers.

### SUMMARY

The subject invention is a system for providing targeted information to a consumer while the consumer is at a particular location. Particularly, the subject invention is a system that provides targeted information to a group of consumers while the group of consumers is at a store. More particularly, the subject invention is a system that provides targeted advertisements to consumers during a point of decision for the consumers while the consumers are at a particular location.

In accordance with an aspect of the subject invention, there is provided a method for providing a targeted message at a location. The method comprises the steps of: (a) obtaining data regarding a consumer who is at a location; (b) providing the obtained consumer data to collective consumer data of a pool of consumers who are at the location; (c) determining a consumer characteristic from the collective consumer data of the pool of consumers who are at the location; (d) selecting a message in accordance with the determined consumer characteristic of the pool of consumers who are at the location; and (e) providing the selected message to the location.

In accordance with another aspect of the subject invention, there is provided a system for providing a targeted message to a location. The system includes means for obtaining consumer data of a consumer who is at a location, means for providing the obtained consumer data to collective consumer data of a pool of consumers who are at the location, means for determining a consumer characteristic from the collective consumer data of the pool of consumer who are at the location, means for selecting a message in accordance with the determined consumer characteristic of the pool of consumers who are at the location, and means for providing the selected message to the location.

In accordance with yet another aspect of the subject invention there is provided a system for providing targeted messages to consumers at a location. The system includes a consumer data acquisition device, a processor, a message selector, and a message provider. The consumer data acquisition device is operative to obtain data of a consumer who is at a location and provide the obtained consumer data to collective consumer data of a pool of consumers who are at the location. The processor is in communication with the consumer data acquisition device and is operative to determine a consumer characteristic from the collective consumer data of the pool of consumers who are at the location. The message selector is in communication with the processor and is operative to select a message in accordance with the determined consumer characteristic of the pool of consumers who are at the location. The message provider is in communication with the message selector and is operative to play the selected message at the location.

### BRIEF DESCRIPTION OF THE DRAWINGS

FIG. 1 is a representation of an establishment with an exemplary messaging system in accordance with the principles of the subject invention;

FIG. 2 is a representation of a portion of the establishment of FIG. 1 illustrating various message providers in accordance with the principles of the subject invention; and

FIG. 3 is a flowchart of an exemplary manner of operation of the subject messaging system.

Corresponding reference characters indicate corresponding parts throughout the several views.

### DETAILED DESCRIPTION OF THE INVENTION

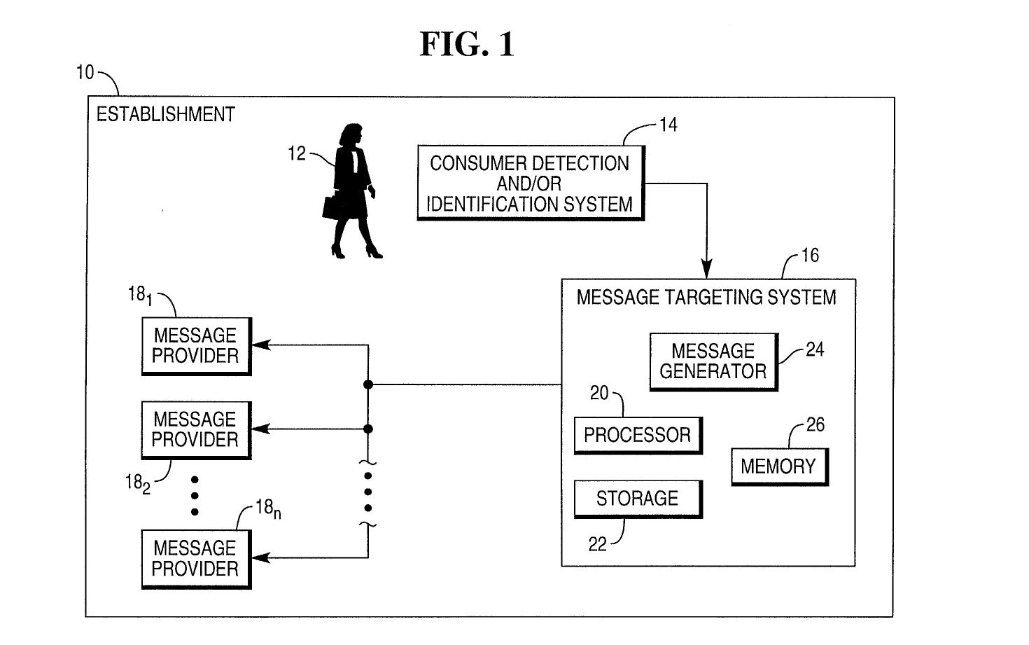

Referring to FIG. 1, there is depicted a representation of an establishment 10. The establishment 10 is illustrative of a location or premises such as a retail store or the like that is open to consumers, of which a consumer 12 is representative. In accordance with the principles of the subject invention, the establishment 10 includes a consumer detection and/or identification system 14 that is in communication with a message targeting system 16. The message targeting system 16 is in communication with a plurality of message providers (generally designated 18) and represented by message providers 18₁, 18₂, through 18ₙ. In one sense, the consumer detection and/or identification system 14, the message targeting system 16, and the message providers 18, each may be considered a subsystem of an overall targeted consumer information dispersal system.

The consumer detection and/or identification system 14 is operative to identify and/or obtain data regarding a consumer 12 that is entering or has entered the establishment 10. The obtained identification and/or consumer data is provided to the message targeting system 16 as represented by the arrow from the consumer detection and/or identification system 14 to the message targeting system 16. Such communication may be accomplished via a hardwired configuration or via a wireless configuration.

In one form, the consumer detection and/or identification system 14 may be a kiosk or other consumer accessible device (collectively kiosk) that is operative to receive consumer data from a loyalty card, shopper card, identification card, or the like (collectively consumer card). The consumer card may be a magnetic strip type card, smart card, bar-coded card, or other type of card that has machine-readable indicia. Further, the consumer card may include the consumer information thereon, or provide consumer identification data that allows the consumer detection and/or identification system 14 or the message targeting system 16 to obtain consumer data from storage once the consumer's identification has been determined. In this form, the consumer 12 would log onto the kiosk upon entering the establishment 10. The consumer detection and/or identification system 14 then forwards the data obtained from the consumer card to the message targeting system 16. The kiosk could be located anywhere within the establishment 10, but would preferably be located at an entrance to the establishment 10. Further, the kiosk may have other functionality such as is typical of kiosks and thus incorporate the functionality and/or features of the subject invention therein.

In another form, the consumer detection and/or identification system 14 may be a scanner or field generator/detector that is operative to detect an identification card such as a transponder type card or a smart card (collectively scanner card). In this form, the scanner or field generator/detector would obtain the consumer data/information from the scanner card when the consumer 12 enters the establishment 10. Like the kiosk embodiment, the scanner card may include the consumer information thereon, or provide consumer identification data that allows the consumer detection and/or identification system 14 or the message targeting system 16 to obtain consumer data from storage once the consumer's identification has been determined. The scanner or field generator/detector would preferably be located at an entrance to the establishment where the scanner or field generator/detector could interrogate a consumer entering the establishment to obtain the consumer data from the scanner card. In this form, the consumer 12 does not need to do an activity.

In another form, the consumer detection and/or identification system 14 may be a physical recognition system that is operative to scan and/or obtain data regarding a physical feature of the consumer. The physical recognition system is preferably located at an entrance to the establishment 10 such that a physical characteristic of the consumer 12 may be obtained when the consumer 12 enters the establishment 10. The physical recognition system may be, without being exhaustive, an iris recognition device, a fingerprint recognition device, a facial recognition device, or the like. In some instances, the physical recognition system may not require physical or active participation by the consumer 12 such as with current facial recognition systems. In some instances, such as the fingerprint or iris recognition systems, the consumer detection and/or identification system 14 may require at least some degree of active or consumer participation.

Because of various concerns on behalf of consumers and or problems with making or compelling a consumer to log onto the consumer detection and/or identification system 14 or actively participate in the acquisition of consumer data/information, it is preferable that the consumer detection and/or identification system 14 does not require active participation by the consumer 12 or at least requires only minimum activity or participation by the consumer 12.

The message targeting system 16 includes a processor 20, a storage medium 22, a message generator and transmitter 24, and memory 26. The memory 26 stores program instructions that allow the message targeting system 16 to function in accordance with the present description. The processor, processing unit, and/or processing circuitry/logic 20 is operative to execute the appropriate program instructions and perform the necessary processing of data in accordance with the principles of the subject invention. The storage medium 22 is operative to store consumer data/information both obtained in real time from the consumer detection and/or identification system 14 and historical consumer data/information and/or consumer characteristics. The historical consumer data/information is obtained through previous purchase transactions, consumer surveys, and the like. The consumer data/information contained in the storage 22 is updateable. In one form, the consumer data/information is updated by purchase information obtained by retail terminals (not shown) located in the establishment 10 that are used to consummate retail or purchase transactions.

The message targeting system 16 may also be deemed a targeted marketing system, customer relationship management system, or similar system, and thus have the characteristics and/or attributes of same. The message targeting system 16 is operative to receive the consumer data from the consumer detection and/or identification system 14 and ascertain a characteristic or characteristics regarding the consumer either directly from the consumer detection and/or identification system 14 or from the storage 22 of the message targeting system 16. The message targeting system 16 takes the characteristic(s) of the consumer 12 and creates or updates a consumer characteristics pool for consumers that are in the establishment 10. While the message targeting system 16 may perform its operation as described herein with respect to an individual consumer, for privacy and/or anonymity concerns, the message targeting system 16 utilizes a pool of consumers on location (at the establishment 10). Particularly, the message targeting system 16 adds the characteristics of each consumer that is in the establishment 10 to the consumer characteristics pool. This naturally necessitates the removal of consumer characteristics for consumers that have left the establishment 10. This will be discussed in detail below. The consumer characteristics pool is thus updated in real-time both with respect to incoming consumers and outgoing consumers.

The message targeting system 16 utilizes the consumer characteristics pool to select and/or generate via the message selector/generator 24 a message, messages, or set of messages to distribute to the message providers 18. The targeted message(s) may, without being exhaustive, consist of targeted advertisements, services deemed appropriate and/or applicable to the group of consumers at the establishment 10, or other such messages. In the present context and unless otherwise indicated, it should be appreciated that a message is audio and/or video information (collectively audio/video information). The audio/video information may constitute an advertisement, offer, infomercial, or the like. The message(s) are typically pre-recorded and retained in the storage 22. As such, the message targeting system 16 is operative to accept messages, modify messages, and delete messages. The messages may be provided to the message targeting system 16 by outside sources such as vendors, may be produced “in-house”, or be a combination thereof. Vendors may be charged a fee to have their message be a part of the subject message targeting system.

In one form, a message is considered targeted in that it relates to the deemed characteristics of a majority of the consumers currently at the establishment 10. For example, if the consumer characteristics pool determines that ten (10) of the currently twelve (12) identified people (i.e. consumers that have actively logged into the system or have been passively identified by the system) in the establishment 10 have young children (based on previous purchase history), the message targeting system 16 generates and/or provides a message throughout the establishment 10 regarding diapers or other young children product.

In one form, the targeted message is provided to the plurality of message providers 18. The message targeting system 16 determines the number of times, the interval between replay of the message, and/or how long the particular message will be provided to the message providers 18. The targeted consumer information dispersal system re-evaluates the targeted messages (the consumer characteristics pool) upon the occurrence of an event. An event may be a time period or interval, the detection and/or identification of another consumer entering the establishment 10, the checkout of a “logged in” consumer, the egress of a “logged in” consumer from the establishment 10, or other event. In one form, each identified consumer characteristic or attribute may be on a timer and thus purged from the system after the timer has expired. The timer may be set to an average length of stay of a consumer in the particular establishment 10.

With respect to a consumer leaving the establishment 10, in one form, the consumer detection and/or identification system 14 may be configured to detect that a consumer is leaving (or has left) in the same manner as the detection of a consumer entering (or has entered) the establishment by detecting a consumer card and then checking the identification against those consumers already detected or identified. If the consumer has already been identified, then it would assume that the consumer is leaving. The system would then log out the consumer and re-evaluate the consumer characteristics pool and thus the targeted messages. In another form, during checkout at a retail terminal, self-checkout, or the like (collectively purchase transaction terminal), the swiping of the consumer card into the purchase transaction terminal would log out the consumer and cause re-evaluation.

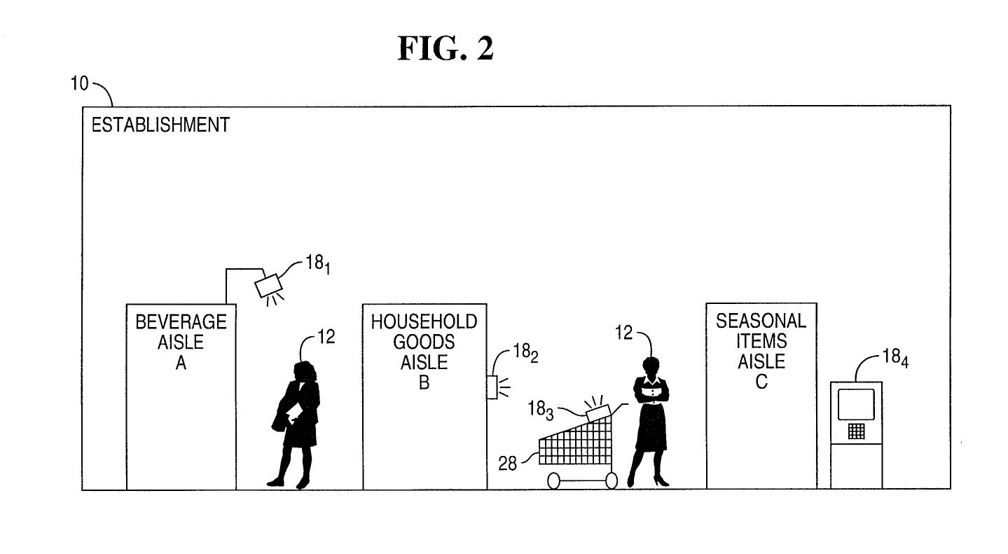

Referring to FIG. 2, the establishment 10 is illustratively represented as a retail store. The establishment 10 includes a number or plurality of aisles, here represented aisle A, aisle B, and aisle C, and typically other areas that are not shown or represented. In the present example, aisle A is arbitrarily a “beverage aisle”, aisle B is arbitrarily a “household goods aisle”, and aisle C is arbitrarily a “seasonal items aisle”. The message providers 18 are preferably distributed throughout the establishment 10 and may comprise one or more types of audio/video players or devices. Shown in FIG. 2 as non-exhaustive examples of message providers is a television 18₁ provided in the beverages aisle, an electronic shelf-talker (or other shelf mounted audio/video device) 18₂ provided in the household goods aisle, a kiosk 18₄ provided in the seasonal items aisle, and a portable or mountable electronic audio/video device 18₃ provided on a shopping cart 28. It should be appreciated that the message providers 18₁, 18₂ and 18₄ are in communication with the message targeting system 16 via a hard-wired configuration or a wireless configuration, while the message provider 18₃ is in communication with the message targeting system 16 via a wireless configuration. While not specifically shown, a PDA or the like either owned by the consumer 12 or provided by the establishment 10 may also be used on a wireless basis. Of course, other types of message providers may be utilized.

With continued reference to FIG. 2, illustrations regarding the subject invention will be described. According to one illustration, each message provider 18₁, 18₂, 18₃, 18₄, is provided with the same targeted messages according to the consumer characteristics pool. Preferably, the targeted messages are provided in sets of different messages to the consumers.

According to another illustration, the establishment 10 may be divided into sections with a message provider (or message providers) in each section receiving and playing different targeted messages. Preferably, each section would receive and play targeted messages according to the type of items within the section or services related thereto. For example and arbitrarily for illustrative purposes, each aisle A, B, and C is a different section. In this case, the television 18₁ would receive a particular set of targeted messages typically related to beverages since aisle A is the beverage aisle and the television 18₁ is located in aisle A. At the same time, the electronic shelf talker 18₂ would receive a particular set of targeted messages typically related to household goods since aisle B is the household goods aisle and the electronic shelf-talker 18₂ in located in aisle B. Likewise, at the same time, the kiosk 18₄ would receive a particular set of targeted messages typically related to seasonal items since aisle C is the seasonal items aisle and the kiosk 18₄ is located in aisle C. Since the shopping cart 28 is mobile, the message provider 18₃ could receive a fourth set of targeted messages. Of course other configurations and/or set-ups may be provided within the establishment 10.

Operation

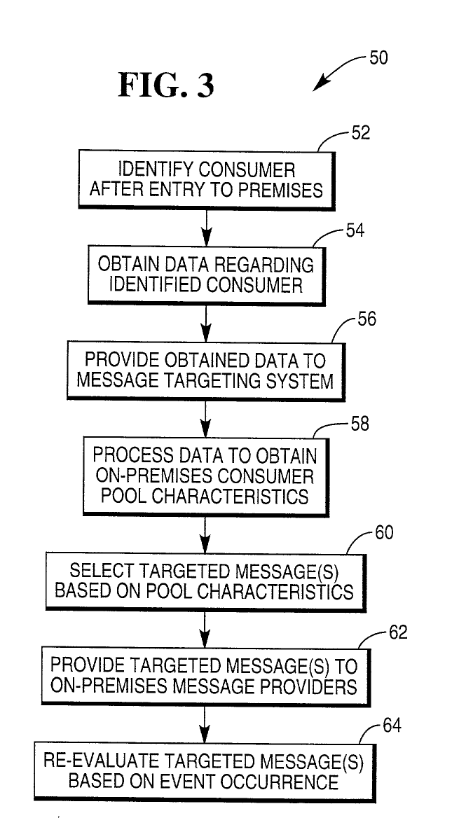

Referring to FIG. 3, there is depicted a flow chart, generally designated 50, of an exemplary manner of operation of an aspect of the subject invention. In particular, there is depicted the flow chart 50 of an exemplary manner of operation of the subject messaging system. Initially, in step 52, a consumer is identified after entering the premises of an establishment. After the consumer enters the establishment, in step 54, consumer data is obtained regarding the identified consumer. In step 56, the obtained consumer data is provided to the message targeting system.

In step 58, the message targeting system processes the consumer data against a consumer characteristics pool to obtain an on-premises consumer pool characteristics. In step 60, the message targeting system then selects a targeted message or targeted messages according to or based on the consumer pool characteristics. In step 62, the targeted message or messages are sent to the message providers to be played thereon. Finally, in step 64, the message system re-evaluates the targeted messages when or based on the occurrence of an event.

While this invention has been described as having a preferred design, the subject invention can be further modified within the spirit and scope of this disclosure. This application is therefore intended to cover any variations, uses, or adaptations of the subject invention using its general principles. Further, this application is intended to cover such departures from the present disclosure as come within known or customary practice in the art to which this invention pertains and that fall within the limits of the appended claims.

What is claimed is:

1. A method for providing a targeted message at a location, the method comprising the steps of:
obtaining data regarding a consumer who is at a location;
providing the obtained consumer data to collective consumer data of a pool of consumers who are at the location;
determining a consumer characteristic from the collective consumer data of the pool of consumers who are at the location;
selecting a message in accordance with the determined consumer characteristic of the pool of consumers who are at the location; and
providing the selected message to the location.

2. The method of claim 1, wherein the step of obtaining data regarding a consumer who is at the location includes the step of identifying the consumer who is at the location.

3. The method of claim 2, wherein the step of identifying a consumer who is at the location includes the step of:
utilizing a physical attribute recognition system.

4. The method of claim 1, wherein the step of providing the selected message to the location includes providing the selected message to the location via a plurality of message providers.

5. The method of claim 1, wherein:
the step of providing the selected message to the location includes providing the selected message to the location on one of a plurality of message providers; and
further comprising the steps of:
determining a second consumer characteristic from the collective consumer data of the pool of consumers who are at the location;
selecting a second message in accordance with the second determined consumer characteristic; and
providing the second selected message to the location on another one of the plurality of message providers.

6. The method of claim 1, further comprising the steps of:
removing the obtained data regarding the consumer who is at the location from the collective consumer data of the pool of consumers who are at the location upon the occurrence of an event;
re-determining a consumer characteristic from the collective consumer data of the pool of consumers who are remaining at the location;
selecting a new message in accordance with the re-determined consumer characteristic of the pool of consumer who are remaining at the location; and
providing the newly selected message to the location.

7. The method of claim 6, wherein the occurrence of an event comprises expiration of a time period.

8. The method of claim 6, wherein the occurrence of an event comprises determining whether the consumer has left the location.

9. A system for providing a targeted message to a location comprising:
means for obtaining consumer data of a consumer who is at a location;
means for providing the obtained consumer data to collective consumer data of a pool of consumers who are at the location;
means for determining a consumer characteristic from the collective consumer data of the pool of consumer who are at the location;
means for selecting a message in accordance with the determined consumer characteristic of the pool of consumers who are at the location; and
means for providing the selected message to the location.

10. The system of claim 9, wherein said means for obtaining consumer data comprises means for identifying a consumer who is at the location.

11. The system of claim 10, wherein said means for identifying a consumer who is at the location comprises a physical recognition system.

12. The system of claim 9, wherein said means for providing the selected message to the location comprises a plurality of message providers.

13. The system of claim 9, wherein:
said means for providing the selected message to the location includes means for providing the selected message to the location on one of a plurality of message providers; and
further comprising:
means for determining a second consumer characteristic from the collective consumer data of the pool of consumers who are at the location;
means for selecting a second message in accordance with the second determined consumer characteristic; and
means for providing the second selected message to the location on another one of the plurality of message providers.

14. The system of claim 9, further comprising:
means for removing the obtained data regarding the consumer who is at the location from the collective consumer data of the pool of consumers who are at the location upon the occurrence of an event;
means for re-determining a consumer characteristic from the collective consumer data of the pool of consumers who are remaining at the location;
means for selecting a new message in accordance with the re-determined consumer characteristic of the pool of consumer who are remaining at the location; and
means for providing the newly selected message to the location.

15. The system of claim 14, wherein said occurrence of an event comprises expiration of a time period.

16. The system of claim 14, wherein sad occurrence of an event comprises determining whether the consumer has left the location.

17. A system for providing targeted messages to consumers at a location, the system comprising:
a consumer data acquisition device operative to obtain data of a consumer who is at a location and provide the obtained consumer data to collective consumer data of a pool of consumers who are at the location;
a processor in communication with said consumer data acquisition device and operative to determine a consumer characteristic from the collective consumer data of the pool of consumers who are at the location;
a message selector in communication with said processor and operative to select a message in accordance with said determined consumer characteristic of the pool of consumers who are at the location; and
a message provider in communication with said message selector and operative to play the selected message at the location.

18. The system of claim 17, wherein said consumer data acquisition device comprises a kiosk.

19. The system of claim 17, wherein said consumer data acquisition device comprises a physical attribute detector.

20. The system of claim 17, further comprising a plurality of message providers each one of which is in communication with said message selector; and wherein:
said processor is further operative to determine a second consumer characteristic from the collective consumer data of the pool of consumers who are at the location;
said message selector is further operative to select a second message in accordance with the second determined consumer characteristic; and
another one of said plurality of message providers is operative to play said second selected message at the location.
